(19) United States
(12) Patent Application Publication
(10) Pub. No.: US 2014/0204078 A1
(43) Pub. Date: Jul. 24, 2014

(54) MULTI-VIEW THREE DIMENSIONAL DISPLAY SYSTEM AND CONTROL METHOD THEREOF

(71) Applicant: AU Optronics Corp., Hsin-Chu (TW)

(72) Inventors: Yu-Chu Chen, Hsin-Chu (TW); Chia-Pu Ho, Hsin-Chu (TW)

(73) Assignee: AU Optronics Corp., Hsin-Chu (TW)

(21) Appl. No.: 14/045,799

(22) Filed: Oct. 4, 2013

(30) Foreign Application Priority Data
Jan. 23, 2013 (TW) 102102478

(51) Int. Cl. G06T 15/00

(52) U.S. Cl. CPC G06T 15/00
USPC 345/419

(57) ABSTRACT

Multi-view three dimensional display system has N views. A control method for the multi-view three dimensional display system includes determining a number M of image frames, which will be displayed in the N views, according to at least one user's viewing position, and displaying the M image frames in the N views of the multi-view three dimensional display system.

### BACKGROUND

1. Technical Field

The document is related to a method for controlling a multi-view three dimensional display system, and more particularly, to a method for controlling multi-view three dimensional display system capable of adjusting number of image frames.

2. Related Art

With the advancement of display technology, autostereoscopic three dimensional (3D) displays have become reality. However, dead zones where image frames cannot form 3D images in user's eyes exist in boundaries of different periods of image frames projected from an autostereoscopic 3D display to the user's viewing position. The user at the said viewing position may feel dizzy and not able to focus on a 3D image because image frames for right eye and left eye are reversed. What's worse, when there are more than one user watching the autostereoscopic 3D display at the same time, it is difficult to adjust image frames projected to all users' viewing positions correctly for preventing each user from being located at dead zones because each user is in a different location relative to the autostereoscopic 3D display, thus how to adjust image frames projected from the autostereoscopic 3D display to correct viewing positions for each user is worth developing.

### SUMMARY

An embodiment of the disclosure discloses a method for controlling multi-view three dimensional display system. The multi-view three dimensional display system has N views. The method comprises determining a number M of image frames displayed in the N views of the multi-view three dimensional display system according to at least one user's viewing position, and displaying the M image frames in the N views of the multi-view three dimensional display system, wherein M≦N.

Another embodiment of the disclosure discloses a control method for multi-view three dimensional display system. The multi-view three dimensional display system has N views. The method comprises determining an arrangement of a number M of image frames displayed in the N views of the multi-view three dimensional display system according to at least one user's viewing position, and displaying the M image frames in the N views of the multi-view three dimensional display system according to the arrangement, wherein M≦N.

Another embodiment of the disclosure discloses a multi-view three dimensional display system. The system comprises a detector, a display device, and a processor. The detector is for detecting at least one user's viewing position. The display device comprises a display unit and an optical unit. The display unit may be configured to display image frames, and the optical unit may be configured to provide N views of the multi-view three dimensional display system and display M image frames in the N views in conjunction with the display unit. The processor may be configured to control the display unit to display the image frames and to determine the number M of image frames displayed in the N views of the multi-view three dimensional display system according to the at least one user's viewing position, wherein M≦N.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a multi-view three dimensional display system according to an embodiment.

FIG. 2 is a flowchart illustrating a control method for multi-view three dimensional display system according to an embodiment.

FIG. 3 is a diagram illustrating the method of FIG. 2 according to an embodiment.

FIG. 4 is a diagram illustrating the method of FIG. 2 according to another embodiment.

FIG. 5 is a diagram illustrating the method of FIG. 2 according to another embodiment.

### DETAILED DESCRIPTION

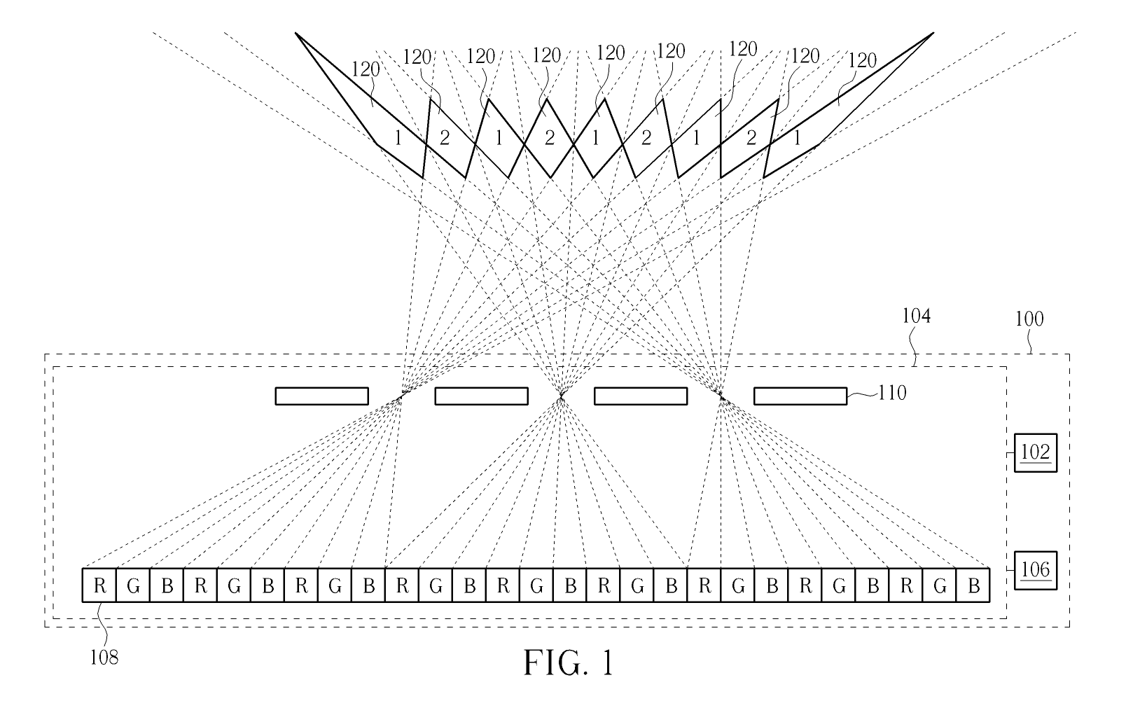

FIG. 1 is a diagram illustrating a multi-view three dimensional (3D) display system 100 according to an embodiment. The multi-view 3D display system 100 (hereinafter also referred as the display system 100) may include a detector 102, a display device 104, and a processor 106. The display device 104 may include a display unit 108 and an optical unit 110.

The detector 102 may be configured to detect at least one user's viewing position relative to the display system 100. The display unit 108 may include a plurality of pixels and may be configured to display image frames. The optical unit 110 may include a parallax barrier (as shown in FIG. 1) or a lenticular lens. The optical unit 110 may be configured to provide N views 120 of the display system 100 and display M image frames in the N views 120 in conjunction with the display unit 108. To be more specific, there are 9 views 120 in FIG. 1 so N=9 and there are 2 image frames, which are marked as 1 and 2, repeatedly displayed in the views 120 in FIG. 1 so M=2. In all embodiments of the disclosure, the M image frames displayed in the N views 120 are arranged repeatedly according to the number M of image frames. For example, M=2 in FIG. 1 so the M image frames displayed in the N views 120 are arranged repeatedly in a sequence marked as 1, 2, 1, 2. The processor 106 may be configured to control the display unit 108 to display the image frames and determine the number M of image frames displayed in the N views 120 of the display system 100 according to the at least one user's viewing position. M and N are integers and M≦N. For example, M=2 in FIG. 1 so the display system 100 may display the 2 image frames marked as 1 and 2 respectively in the views 120 and each pair of the 2 image frames marked as 1 and 2 in the views 120 forms a three dimensional image in the at least one user's right eye and left eye. If the at least one user's left eye is at the view 120 showing the image frame marked as 1 and the at least one user's right eye is at the view 120 showing the image frame marked as 2, the at least one user can see the three dimensional image. On the other hand, if the at least one user's left eye is at the view 120 showing the image frame marked as 2 and the at least one user's right eye is at the view 120 showing the image frame marked as 1, the at least one user is located in a dead zone and cannot see the three dimensional image.

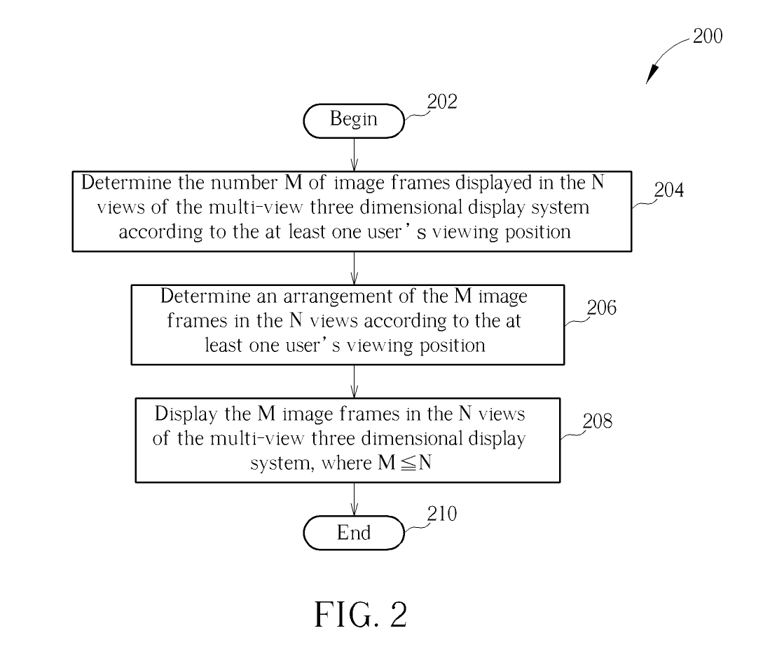

FIG. 2 is a flowchart illustrating a control method 200 for multi-view three dimensional display system according to an embodiment. The method 200 of FIG. 2 may be configured to control the multi-view three dimensional display system 100 in order to solve the problem that the at least one user may be located in the dead zone. The method 200 may include the following steps.

Step 202: Begin.

Step 204: Determine the number M of image frames displayed in the N views 120 of the multi-view three dimensional display system 100 according to the at least one user's viewing position.

Step 206: Determine an arrangement of the M image frames in the N views 120 according to the at least one user's viewing position.

Step 208: Display the M image frames in the N views 120 of the multi-view three dimensional display system 100, where M≦N.

Step 210: End.

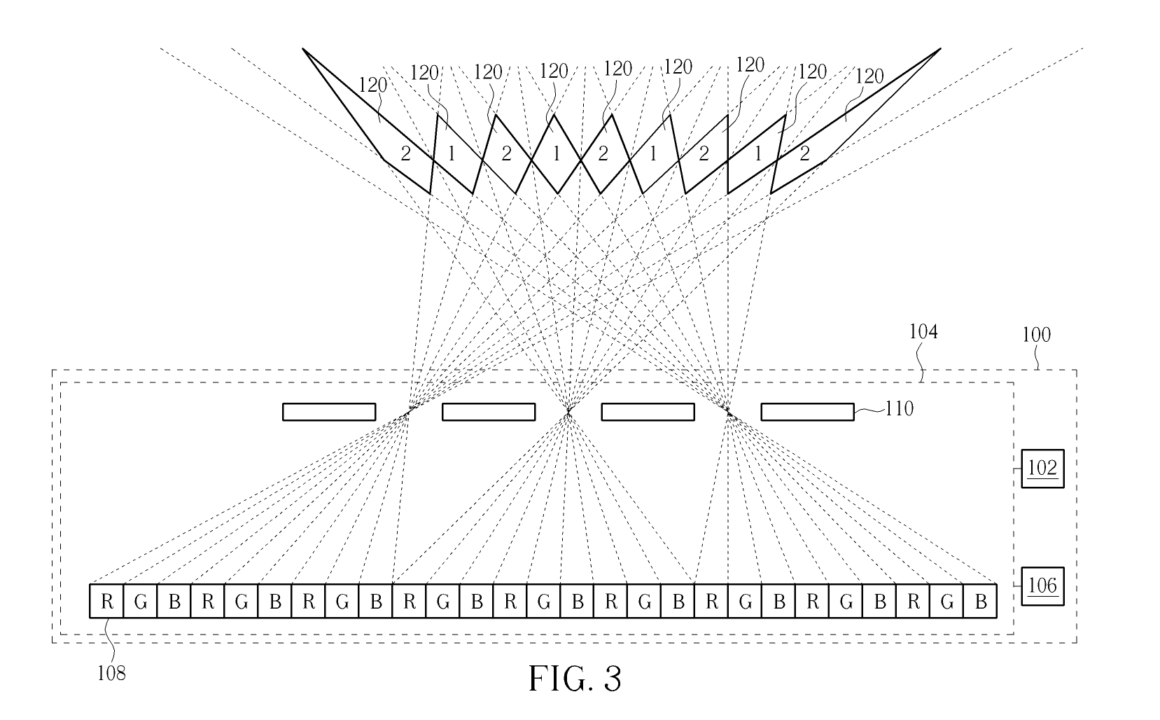

In an embodiment, supposing the display system 100 of FIG. 1 initially displays M=2 image frames in the N views 120 and there is only one user, if the 2 image frames displayed at the user's viewing position do not correspond to the user's left eye and right eye (that is the user's left eye sees a image frame supposedly to be seen by right eye and the user's right eye sees a image frame supposedly to be seen by left eye), namely, the dead zone, the display system 100 may maintain the number M=2 image frames in the N views 120 and adjust the arrangement of the 2 image frames in the N views 120 by the processor 106 as described in step 206, such as exchange the 2 image frames, to correspond the 2 image frames displayed at the user's viewing position to the user's left eye and right eye. As illustrated in FIG. 3, which is a diagram illustrating the method 200 of FIG. 2 according to an embodiment, image frames marked as 1 and 2 in the views 120 of FIG. 1 are switched from left to right and from right to left in FIG. 3. That is, the 2 image frames are arranged in a different way in FIG. 3. Embodiments of the disclosure are not limited thereto, the 2 image frames marked as 1 and 2 in the views 120 may shift rightward or leftward according to the user's viewing position so that the 2 image frames may correspond to the user's left eye and right eye. The processor 106 may control the display unit 108 to adjust the arrangement of the M image frames in the N views 120 by changing weightings of grey levels of the plurality of pixels in the display unit 108.

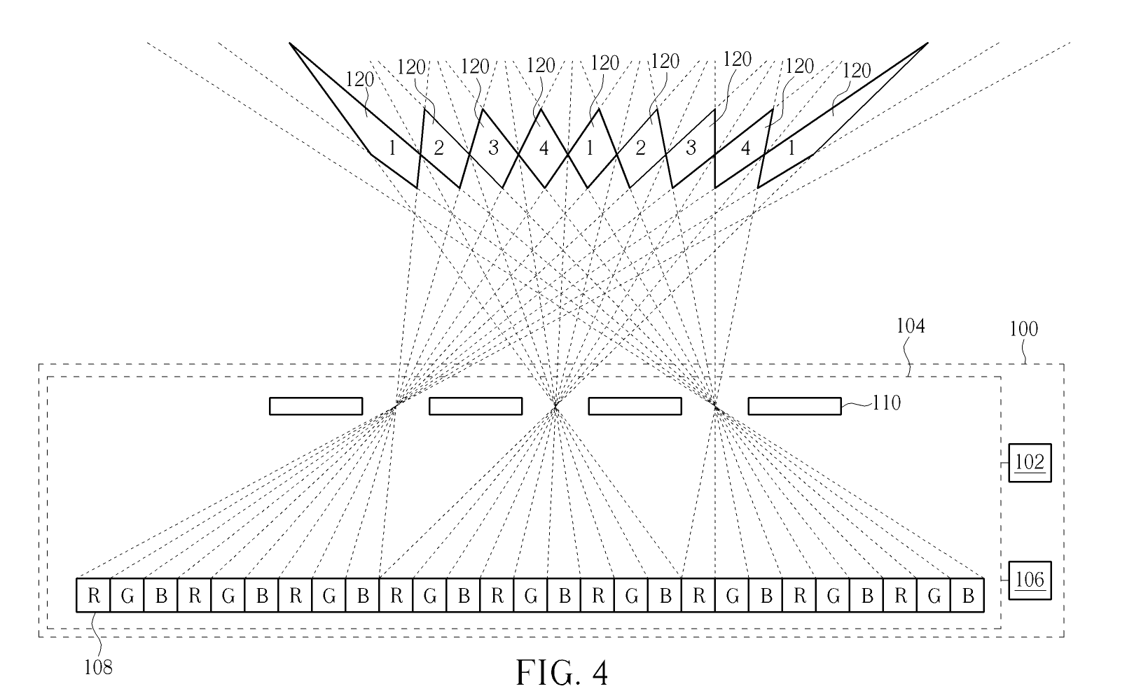

In another embodiment, supposing the display system 100 of FIG. 1 initially displays M=2 image frames in the N views 120 and there are two users watching the display system 100 at the same time, if the two users are both located in dead zones, the display system 100 may maintain the number M=2 image frames in the N views 120 and adjust the arrangement of the 2 image frames in the N views 120 as described in step 206 and FIG. 3 to correspond the 2 image frames displayed at the two users' viewing positions to both the two users' left eyes and right eyes. If only one of the two users is located in the dead zone and the other of the two users is located in a viewing position corresponding to left eye and right eye, merely exchanging the 2 image frames as described above may not be enough to correspond the 2 image frames to both the two users' left eyes and right eyes, that is, one of the two users may remain in the dead zone. Step 204 may be performed to handle this kind of situation. The processor 106 may control the display unit 108 to adjust the number M of image frames in the N views 120, for example, the number M=2 image frames may be adjusted to be M=4 image frames, and the M=4 image frames may be arranged in a proper way in order to correspond the 4 image frames to both the two users' left eyes and right eyes. As illustrated in FIG. 4, which is a diagram illustrating the method 200 of FIG. 2 according to another embodiment, adjacent image frames in the views 120 of FIG. 4 form three dimensional images in the at least one user's right eye and left eye. For example, image frames marked as 1 and 2 in the views 120 may correspond to the at least one user's right eye and left eye, image frames marked as 2 and 3 in the views 120 may also correspond to the at least one user's right eye and left eye, and image frames marked as 3 and 4 in the views 120 may also correspond to the at least one user's right eye and left eye, but image frames marked as 4 and 1 in the views 120 do not correspond to the at least one user's right eye and left eye. If the number M has been adjusted to be 4 image frames but is not enough to correspond the 4 image frames to both the two users' left eyes and right eyes, that is, one of the two users may remain in the dead zone such as in a location between image frames marked as 4 and 1 in the views 120, step 206 may be performed to further adjust an arrangement of the 4 image frames such as shifting the 4 image frames leftward or rightward (for example, the 4 image frames marked as 1, 2, 3, 4 from left to right repeatedly in the views 120 may be adjusted to be 4, 1, 2, 3 from left to right repeatedly) so that the user located between image frames marked as 4 and 1 in the views 120 may be located between image frames 3 and 4 in the views 120, thus the 4 image frames displayed at both the two users' viewing positions may correspond to both the two users' left eyes and right eyes.

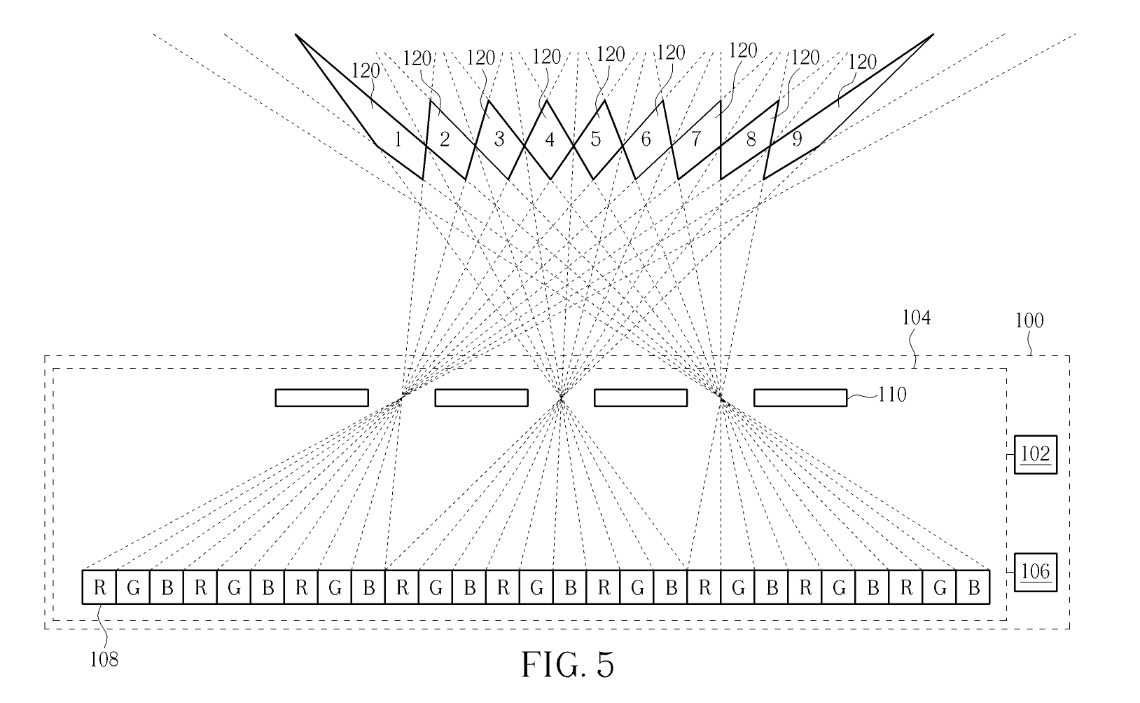

In another embodiment, supposing the display system 100 of FIG. 1 initially displays M=2 image frames in the N views 120 and there are three users watching the display system 100 at the same time, if the three users are all located in dead zones, the display system 100 may maintain the number M=2 image frames in the N views 120 and adjust the arrangement of the 2 image frames in the N views 120 as described in step 206 and FIG. 3 to correspond the 2 image frames displayed at the three users' viewing positions to all the two users' left eyes and right eyes. If one of the three users is located in the dead zone and others of the three users are located in viewing positions corresponding to their left eyes and right eyes or if two of the three users are located in dead zones and the other of the three user is located in a viewing position corresponding to left eye and right eye, then as shown in FIG. 4 and in step 204, the number M of image frames in the views 120 may be adjusted, such as M=2 image frames may be adjusted to be M=4 image frames, and step 206 may further be performed to adjust the arrangement of the 4 image frames in the N views 120, such as shifting the 4 image frames leftward or rightward so that the 4 image frames displayed at all the three users' viewing positions may correspond to all the three users' left eyes and right eyes. If the methods set forth are not enough to correspond the 4 image frames to all the three users' left eyes and right eyes, step 204 may be performed to handle this kind of situation. The processor 106 may control the display unit 108 to adjust the number M of image frames in the N views 120, for example, the number M=4 image frames may be adjusted to be M=9 image frames in order to correspond the 9 image frames to all the three users' left eyes and right eyes. As illustrated in FIG. 5, which is a diagram illustrating the method 200 of FIG. 2 according to another embodiment, adjacent image frames in the views 120 of FIG. 5 form three dimensional images in the at least one user's right eye and left eye. For example, image frames marked as 1 and 2 in the views 120 may correspond to the at least one user's right eye and left eye, image frames marked as 2 and 3 in the views 120 may also correspond to the at least one user's right eye and left eye, image frames marked as 3 and 4 in the views 120 may also correspond to the at least one user's right eye and left eye, image frames marked as 4 and 5 in the views 120 may also correspond to the at least one user's right eye and left eye, image frames marked as 5 and 6 in the views 120 may also correspond to the at least one user's right eye and left eye, and so on. If the number M has been adjusted to be 9 image frames and is still not enough to correspond the 9 image frames to all the three users' left eyes and right eyes, step 206 may be performed to further adjust an arrangement of the 9 image frames such as shifting the 9 image frames leftward or rightward (for example, the 9 image frames marked as 1 to 9 from left to right in the views 120 may be adjusted to be 9, 1 to 8 from left to right) so that the 9 image frames displayed at all the three users' viewing positions may correspond to all the three users' left eyes and right eyes.

When the display system 100 is control by the method 200, if it is feasible to correspond image frames displayed at the at least one user's viewing position to the at least one user's left eye and right eye by maintaining the number M of image frames in the N views 120 and adjusting the arrangement of the M image frames in the N views 120 or by adjusting the number M of image frames in the N views 120 and displaying the M image frames in the N views 120 of the display system 100, the method 200 firstly(prefer) maintains the number M of image frames in the N views 120 and adjusts the arrangement of the M image frames in the N views 120. In addition, the method 200 firstly adjusts the number M of image frames to be the smallest number that can practically correspond the image frames displayed at the at least one user's viewing position to the at least one user's left eye and right eye. For example, if the number M=4 image frames is practical to correspond the image frames displayed at the at least one user's viewing position to the at least one user's left eye and right eye, the number M will not be adjusted to M=9 so as to save calculation time of the processor 106 and to achieve as high resolution of each image frame as possible.

Embodiments of the disclosure are not limited to three users described hereinabove, the method 200 may adapt for more than three users. Further, even the number M of image frames has been adjusted to be 9 when there are three users watching the display system 100 at the same time, the number M of image frames may still be adjusted to be 4 or 2, and/or the arrangement of M image frames may be adjusted by adapting the method 200 if at least one user of the three users leaves and no longer watching so as to correspond the image frames displayed at the at least one user's viewing position to the at least one user's left eye and right eye.

In summary, the disclosure discloses a method for controlling the display system 100 that can adjust the number M of image frames in the views 120 and can adjust the arrangement of the M image frames in the N views 120, thereby solving the problem that a user may be located in the dead zone where the user cannot see a 3D image and the problem that at least one user of multiple users may be located in the dead zone when the multiple users are watching the multi-view three dimensional display at the same time.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A control method for controlling a multi-view three dimensional display system, the multi-view three dimensional display system having N views, the method comprising:
determining a number M of image frames displayed in the N views of the multi-view three dimensional display system according to at least one user's viewing position; and
displaying the M image frames in the N views of the multi-view three dimensional display system, wherein M≦N.

2. The method of claim 1, wherein when one of the image frames displayed at the at least one user's viewing position do not correspond to the at least one user's left eye and right eye, the multi-view three dimensional display system maintains the number M of image frames in the N views and adjusts an arrangement of the M image frames in the N views in order to make the image frames displayed at the at least one user's viewing position corresponding to the at least one user's left eye and right eye.

3. The method of claim 1, wherein when one of the image frames displayed at the at least one user's viewing position do not correspond to the at least one user's left eye and right eye and the multi-view three dimensional display system can correspond the image frames displayed at the at least one user's viewing position to the at least one user's left eye and right eye by maintaining the number M of image frames in the N views and adjusting an arrangement of the M image frames in the N views or by adjusting the number M of image frames in the N views and displaying the M image frames in the N views of the multi-view three dimensional display system, the multi-view three dimensional display system maintains the number M of image frames in the N views and adjusts the arrangement of the M image frames in the N views.

4. The method of claim 1, wherein when M=2 and image frames displayed at the at least one user's viewing position do not correspond to each of the at least one user's left eye and right eye, the multi-view three dimensional display system maintains the number M=2 image frames and adjusts an arrangement of the 2 image frames in the N views.

5. The method of claim 1, wherein when M=2 and only some of the image frames displayed at the at least one user's viewing position do not correspond to the at least one user's left eye and right eye, the multi-view three dimensional display system increases the number M of image frames in the N views.

6. The method of claim 1 further comprising determining an arrangement of the M image frames in the N views according to the at least one user's viewing position.

7. The method of claim 6, wherein when image frames displayed at the at least one user's viewing position do not correspond to the at least one user's left eye and right eye, the multi-view three dimensional display system maintains the number M of image frames in the N views and adjusts the arrangement of the M image frames in the N views to correspond the image frames displayed at the at least one user's viewing position to the at least one user's left eye and right eye.

8. The method of claim 6, wherein when image frames displayed at the at least one user's viewing position do not correspond to the at least one user's left eye and right eye and the multi-view three dimensional display system can correspond the image frames displayed at the at least one user's viewing position to the at least one user's left eye and right eye by maintaining the number M of image frames in the N views and adjusting the arrangement of the M image frames in the N views or by adjusting the number M of image frames in the N views and displaying the M image frames in the N views of the multi-view three dimensional display system, the multi-view three dimensional display system firstly maintains the number M of image frames in the N views and adjusts the arrangement of the M image frames in the N views.

9. The method of claim 6, wherein when M=2 and image frames displayed at the at least one user's viewing position do not correspond to each of the at least one user's left eye and right eye, the multi-view three dimensional display system maintains the number M=2 image frames and adjusts the arrangement of the 2 image frames in the N views.

10. The method of claim 6, wherein when M=2 and image frames displayed at the at least one user's viewing position do not correspond to some of the at least one user's left eye and right eye, the multi-view three dimensional display system increases the number M of image frames in the N views.

11. A control method for controlling a multi-view three dimensional display system, the multi-view three dimensional display system having N views, the method comprising:
determining an arrangement of a number M of image frames displayed in the N views of the multi-view three dimensional display system according to at least one user's viewing position; and
displaying the M image frames in the N views of the multi-view three dimensional display system according to the arrangement, wherein M≦N.

12. The method of claim 11, wherein when image frames displayed at the at least one user's viewing position do not correspond to the at least one user's left eye and right eye, the multi-view three dimensional display system maintains the number M of image frames in the N views and adjusts the arrangement of the M image frames in the N views to correspond the image frames displayed at the at least one user's viewing position to the at least one user's left eye and right eye.

13. The method of claim 11, wherein when image frames displayed at the at least one user's viewing position do not correspond to the at least one user's left eye and right eye and the multi-view three dimensional display system can correspond the image frames displayed at the at least one user's viewing position to the at least one user's left eye and right eye by maintaining the number M of image frames in the N views and adjusting the arrangement of the M image frames in the N views or by adjusting the number M of image frames in the N views and displaying the M image frames in the N views of the multi-view three dimensional display system, the multi-view three dimensional display system firstly maintains the number M of image frames in the N views and adjusts the arrangement of the M image frames in the N views.

14. The method of claim 11, wherein when M=2 and image frames displayed at the at least one user's viewing position do not correspond to each of the at least one user's left eye and right eye, the multi-view three dimensional display system maintains the number M=2 image frames in the N views and adjusts the arrangement of the 2 image frames in the N views.

15. The method of claim 11, wherein when M=2 and image frames displayed at the at least one user's viewing position do not correspond to some of the at least one user's left eye and right eye, the multi-view three dimensional display system increases the number M of image frames in the N views.

16. A multi-view three dimensional display system comprising:
a detector for detecting at least one user's viewing position;
a display device comprising:
a display configured to display image frames; and
an optical unit configured to provide N views of the multi-view three dimensional display system and displaying M images image frames in the N views in conjunction with the display; and
a processor configured to control the display unit to display the image frames and for determining the number M of image frames displayed in the N views of the multi-view three dimensional display system according to the at least one user's viewing position, wherein M≦N.

17. The system of claim 16, wherein the processor is further configured to control the image frames displayed by the display unit for maintaining the number M of image frames in the N views and adjusting an arrangement of the M image frames in the N views to correspond image frames displayed at the at least one user's viewing position to the at least one user's left eye and right eye.

18. The system of claim 16, wherein the processor is further configured to control the image frames displayed by the display unit, adjusting the number M of image frames in the N views, and providing the M image frames in the N views of the multi-view three dimensional display system to correspond image frames displayed at the at least one user's viewing position to the at least one user's left eye and right eye.

19. The system of claim 16, wherein the processor is further configured to control the display unit to determine an arrangement of the M image frames in the N views according to the at least one user's viewing position.

20. The system of claim 19, wherein the processor is for controlling the image frames displayed by the display unit for maintaining the number M of image frames in the N views and adjusting the arrangement of the M image frames in the N views to correspond image frames displayed at the at least one user's viewing position to the at least one user's left eye and right eye.

21. The system of claim 19, wherein the processor is for controlling the image frames displayed by the display unit, adjusting the number M of image frames in the N views, and providing the M image frames in the N views of the multi-view three dimensional display system to correspond image frames displayed at the at least one user's viewing position to the at least one user's left eye and right eye.
